(19) United States
(12) Patent Application Publication
(10) Pub. No.: US 2024/0083609 A1
(43) Pub. Date: Mar. 14, 2024

(54) PACKAGED EDIBLE MATERIALS

(71) Applicant: SmartPak Equine LLC, Plymouth, MA (US)

(72) Inventors: Dodd Corby, Plymouth, MA (US); Rebecca Minard, Plymouth, MA (US); Jennifer Bianca, Plymouth, MA (US); Daniel Buttrick, Plymouth, MA (US); Amanda Reisman, Plymouth, MA (US); Danielle Franchi, Plymouth, MA (US); Kerri Walsh, Plymouth, MA (US)

(21) Appl. No.: 18/275,583

(22) PCT Filed: Dec. 14, 2021
(86) PCT No.: PCT/US21/63274

§ 371 Date: Aug. 2, 2023

Related U.S. Application Data
(60) Provisional application No. 63/144,801, filed on Feb. 2, 2021.

(51) Int. Cl. B65B 9/06; B65B 1/32; B65B 1/36; B65B 1/46; B65B 37/00; B65B 37/10; B65B 61/02; B65B 61/26; G07F 17/00

(52) U.S. Cl. CPC B65B 9/06; B65B 1/32; B65B 1/36; B65B 1/46; B65B 37/005; B65B 37/10; B65B 61/025; B65B 61/26; G07F 17/0064; B65B 2220/14; B65B 2220/22

(57) ABSTRACT

In one aspect, methods for producing packaged edible materials are provided. In a further aspect, edible material dispensing apparatus are provided. In additional aspects, pod units are provided including those adapted for containing equine supplement or feed materials.

### CROSS REFERENCE TO RELATED APPLICATION

This application claims the benefit of U.S. Provisional Application 63/144,801, filed on Feb. 2, 2021. The entire contents of this application is incorporated herein by reference in its entirety.

### TECHNICAL FIELD

The present disclosure relates generally to a packaging unit for equine supplements and a method for producing packaged edible materials.

### BACKGROUND

Generally, manufacturers of commercial horse feed add vitamins and minerals to processed grain. The amounts of nutritional additives found in processed grain are targeted toward the average horse. Many horse owners, trainers and veterinarians believe that further nutritional supplementation is beneficial for horses in active training, competition, those with health problems, or those who fall in some general demographic groups (older, pregnant, etc.). Nutritional supplements can consist of vitamins, minerals, amino acids, proteins, herbs, oils, etc., and are intended to provide additional nutritive support for the horse. In addition to supplements, various additives may also be routinely added to equine feed.

Many supplements are marketed in bulk containers in airtight seals to maintain freshness and potency. Such bulk containers present various difficulties in administering supplements. For example, the supplements need to be precisely measured for each horse, a time-consuming process. This increases the risk over or under dosing the horse due to error in measuring. A particular horse's supplement may also vary by day or time of year thus further complicating the feeding process. Bulk containers are often not easily resealed securely, leaving the supplements vulnerable to air exposure and contamination.

Various systems have been developed to simplify the supplement feeding process. For example, various single dose containers or pods have been developed. However, these individually manufactured pods are costly and time consuming to produce. Thus, there is a need to develop a more efficient manufacturing process for supplement pods.

### SUMMARY

The present disclosure provides a method for producing packaged edible materials that are sealed and include identifying information thereon. The method also provides an improved stacking order of multiple packages to reduce overall sizing. The produced packages protect the edible material from air, water, and light while the outside of the packages is capable of being printed on to provide customizable information.

According to one aspect the present disclosure provides a method for producing packaged edible materials that includes selecting one or more edible materials and an amount thereof based on a purchaser's input and dispensing each of the edible materials to a packaging unit. Additionally, the method includes sealing side and ends of the packaging unit and then separating the packaging unit into a predetermined number of pods. The method further includes analyzing each pod of the packaging unit for one or more of metal levels, weight and optical characteristics.

According to an exemplary embodiment, the packaging unit may be formed out of a roll of film material and the roll of film material may be folded in half and sealed on sides and ends thereof to form the packaging unit. The roll of film material may be made of a printable material.

Based on a purchaser's input each of the following may be selected: one or more edible materials and amount thereof, packaging unit, and shipping date. The purchaser's input is stored in and accessed from a database. Additionally, identifying information is added to the packaging unit. In particular, the identifying information may include edible material in the pod, amount of edible material in the pod, and indication of number of pods in packaging unit.

Further, a packaging unit is associated with a detectable tag and the detectable tag may include a radio frequency identification (RFID). The packaging unit containing edible material advances via a transport system through process stations during steps of dispensing and analyzing.

According to an exemplary embodiment of the present disclosure, the method further includes stacking multiple stacking units laterally and vertically. The packaging units may be stacked in varying configuration and adjacent packaging units may be stacked in varying positions. In particular, a first portion of the packaging units may be stacked in an inverted position with respect to a second portion of the packaging units. One or more stacks of packaging units are then transferred to a shipping container.

Additionally, an interior surface of the film material is resistant to air and water. The edible materials within the packaging unit may be equine feed or supplements. Each pod may be made of an edible or compostable film. Alternately, each pod may be made of a paper material. In one embodiment, each pod may be formed to be collapsible. Each pod may also be divided into a plurality of sections based on the number of edible materials dispensed thereinto.

According to another aspect of the present disclosure, an edible material dispensing apparatus is provided. The apparatus includes a reservoir in which a plurality of different edible materials are stored and an output through which the edible materials are dispensed. A controller is configured to read a personalized code and then dispense a predetermined amount and predetermined combination of edible materials through the output based on the personalized code.

In yet further aspects, new packaging units are provided. In one embodiment, pod units are provided that can be filled with edible materials including equine feed or supplement materials.

In one aspect, a pod unit may have divisions or separations to provide a plurality of sections that can be filed with distinct edible materials.

In particular aspects, a pod may comprise, for example as a material of construction, an edible or compostable material including a paper material.

In certain aspects, a pod may have a longest dimension of about 10, 9, 8, 7, 6, 5, 4, 3, 2 1.5 or 1 inches or less.

Notably, the present invention is not limited to the combination of the elements as listed above and may be assembly in any combination of the elements as described herein.

Other aspect of the invention as disclosed infra.

### BRIEF DESCRIPTION OF THE DRAWINGS

The patent or application file contains at least one drawing executed in color. Copies of this patent or patent application publication with color drawings will be provided by the Office upon request and payment of the necessary fee.

The embodiments herein may be better understood by referring to the following description in conjunction with the accompanying drawings in which like reference numerals indicate identically or functionally similar elements, of which:

FIG. 1 illustrates the process of filling the packages with edible material according to an exemplary embodiment of the present disclosure;

FIG. 2 illustrates the process of connecting prefilled packages and printing customer information on the packages according to an exemplary embodiment of the present disclosure;

FIGS. 3A-3B illustrate the packages according to an exemplary embodiment of the present disclosure;

FIGS. 4A-4D illustrate a process of handling pouches according to an exemplary embodiment of the present disclosure;

FIGS. 5A-5B illustrate the completed packages according to an exemplary embodiment of the present disclosure;

FIG. 6 illustrates a pouch according to another exemplary embodiment of the present disclosure;

FIG. 7 illustrates a feeding system according to another exemplary embodiment of the present disclosure;

FIGS. 8A-8B illustrate containers for the pouches according to an exemplary embodiment of the present disclosure;

FIGS. 9A-9C illustrate stacking pouches according to an exemplary embodiment of the present disclosure; and

FIGS. 10A-10C illustrate pouches according to another exemplary embodiment of the present disclosure.

### DETAILED DESCRIPTION

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present disclosure provides an improved manufacturing process for packaging pods containing edible material for various feeds or supplements. The improved process increases production efficiency, produces high quality packaging units, and expands production capacity. The produced packaging units are customizable for different animals based on the purchaser's requirements. Accordingly, the packaging units include labeling printed thereon to provide various identifying information. Although the description herein refers to equine feed and/or supplements, the present disclosure is not limited thereto. Additionally, although the packaging unit described herein is referred to as a pod or pouch, the present disclosure is not limited to a particular shape and any shape capable of accommodating material therein may be formed.

Herein below, a production process will be described with the figures providing details of the automated filling process, customization process, and the final packaging units. The first step in the production process is receiving and storing the raw material of the edible material that will be filled in the packaging unit. A database is also used to store data related to individual purchaser order including for example, products, doses, production zone stops, target weights, ship date, expedite status, and the like. A warehouse control system (WCS) may organize the production process based on such data. For example, various orders may be prioritized based on ship date or expedite status. The orders are transmitted to a production process including ship date, product identification, dose size, well numbers, target weight, and production zones to thus determine a tray size and tray quantity required to fulfill the order.

The production process may include a plurality of different production zones. Different orders may require stops at different productions zones. A radio frequency identification (RFID) may be provided on a tray moving through the manufacturing process to provide routing information throughout the production zones. For example, the production track may be organized in 18 zones from start to finish to batch orders of same product and same dose. Various readers are disposed along the track to read the RFID on the tray and route the tray along the conveyer to a corresponding zone.

### Filling Process

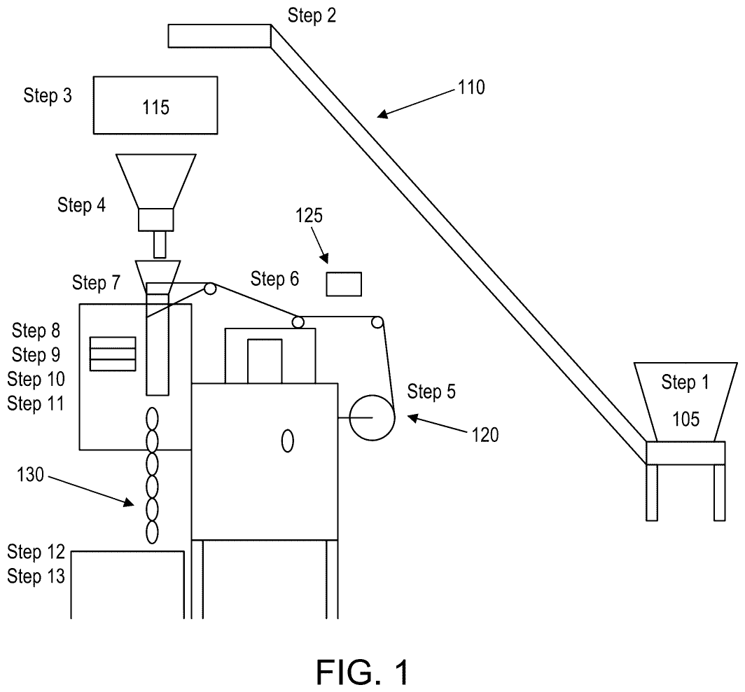

Referring now to FIG. 1, the process of filling the packaging units will be described. This automated filling machine accepts the tray of raw material as well as a film material to produce the filling pouches or pods. The machine may be capable of filling pouches at a rate of about 50-80 pouches/minute depending on the type of edible material.

The filling process begins at step 1 in which the raw material on the tray is dispensed into a hopper 105. At step 2, the material is moved up a conveyer 110 from the hopper into an auger hopper 115 provided at the top of the filling machine. The raw material is then collected in the auger hopper (step 3). This step also includes measuring the weight and volume as the material is being dispensed into the auger hopper. Suitably in step 4, the auger hopper weight and volume may be analyzed by a controller therein which communicates with the bucket from which the material is being dispensed to, for example, slow the dispensing rate, stop dispensing, or dispense more material.

Next, at step 5, a roll of film 120 is operated to form the packaging units in which the material is filled. In one embodiment, the film may be folded and sealed along the edges to form a pouch to be filled with material. Alternately, in another embodiment, two rolls of film may be provided and the film from each roll may be seal together to form the pouch in which the material is filled. The material of the film may include a coating on an inside thereof to protect the material from moisture and light to prevent alteration of the material. Additionally, the outside surface of the film material mater by printable and may also be sealed to another pouch. The film material may be of a strength capable of withstanding unintentional tearing and withstanding punctures during shipping or handling. The film material may be a terephthalate composition. In one embodiment, the film material may be a polyethylene terephthalate, but the present disclosure is not limited thereto.

Moreover, at step 6, a printer 125 along the track is operated to print various identifying information on the film. For example, the product name, amount of material, and bar code identifier may be printed on the film, but the present disclosure is not limited thereto. Additionally, the printed information may be printed in any language or may include images of the contents of the pouch. In another embodiment, a QR code may be printed on the pouch such that the code may be scanned to access contents information. The film is then wrapped or sealed around a filling tube (step 7) to form a void into which the material will be filled from the auger hopper. In particular, a sensor within the auger hopper is capable of sensing the placement of the pouch thereunder and in response, dispense the material into the void of the pouch.

Further, different volume of material may be accommodated within the pouch based on customer preferences or order details. Accordingly, a skip sealer may be provided within the system. The skip sealer is capable of adding a seal at different depths along the length of the pouch to accommodate a reduced volume of material therein (step 8). This additional seal prevents the material from falling to the bottom of the pouch while still allowing the pouch to be separated in equivalent filled pods. This process also prevents the material from remaining on the sides and bottom corners of the pouch when the pod is later opened by a customer.

Next, at step 9, seal plates are operated to seal the pouch after the material has been filled therein. In particular, the seal plates are operated to seal the top, sides, and bottom of the pouch. In one exemplary embodiment, this sealing process includes forming a flange (e.g., about 0.5-0.75 inches in length). Such a flange may be used in a customization process in which the pouches are sealed together. The customization process will be described further herein below. At step 10, a slitter or cutting device is operated to cut the pouch into a particular number of pods. For example, the slitter may form seven pods 130 together, but is not limited thereto. The seven pods may form a single unit providing one week's worth of material (e.g., feed or supplement). At step 11, a hole may be punctured through the flange of every 7th pod (or other predetermined number of pods). This step of the process is optional. The hole allows each strip of pods to be hung in a picking area, a waiting stage between the filling process and the customization process. The uniform hole formed through each strip of pods facilitates the loading of the strips to the next machine.

The final steps of the filling process include confirming accuracy of the fill and moving the pouches to the next steps. In particular, at step 12, a check weight system or similar sensor is used to confirm that each pod contains the predetermined weight of material. If the weight is beyond the acceptable range, the dispensing rate or amount at the auger hopper may be adjusted for the next batch of pouches. The material from the unsatisfactory pouches may be returned to the machine to be refilled in appropriate pouches. Lastly, each strip of pods (seven pods) may be placed into a bin before being moved to the next step in the manufacturing process.

Notably, to accommodate filling the pods with larger sized edible materials or liquid materials, the automated filling machine (e.g., auger system) may be easily supplemented for a different volumetric filling system. For example, a pump system may be used for a liquid filling. Thus, the components within the manufacturing process are fully compatible with a variety of different filling systems.

### Customization

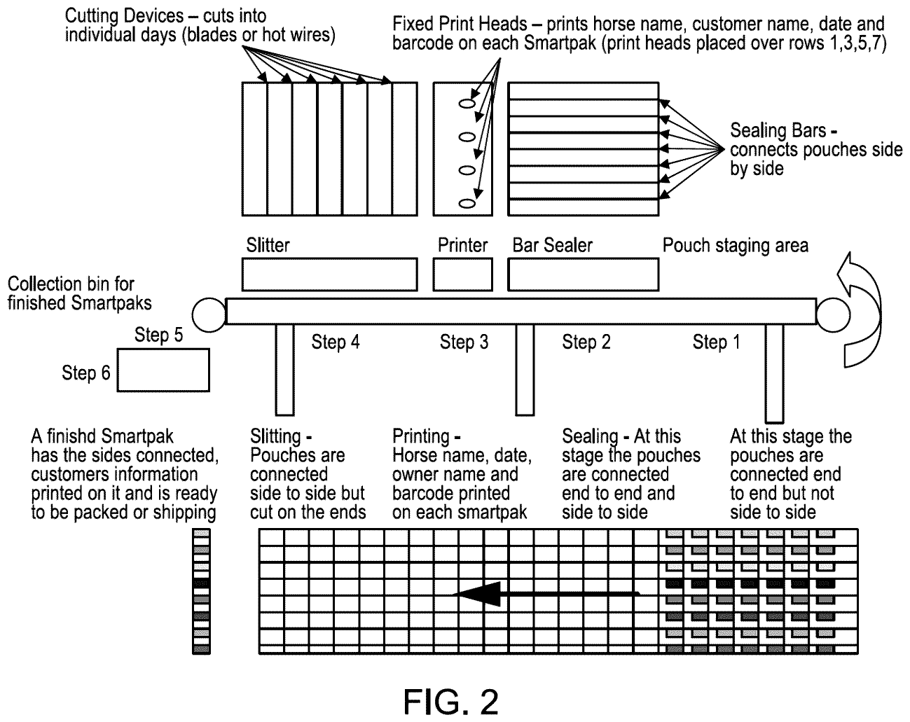

Referring now to FIG. 2, a customization process will be described. In particular, the customization machine shown in FIG. 2 is capable of connecting the prefilled pouches (with separated pods) and printing customer identification information thereon.

To begin the customization process, the pouches (in strips of 7) are loaded onto a stage area against a bar sealer in a manner where the flanges of each pouch overlaps with the next flange (e.g., end to end connection). The overlap of the flanges allows the pouches to be sealed together (e.g., side to side connection). In step 2, the bar sealer is activated. The bar sealer may include a series of heated bars, ultrasonic welders, infrared welders, or other times of connecting mechanism movable vertically to seal the overlapping side flanges of each pouch to thus form a sheet of pouches. Next, at step 3, the sheet of pouches is moved to the printer zone. The printer itself may include numerous printer heads (e.g., about 4) and may be an ink jet printer, a thermal, printer, or the like. In particular, various identifying information may be printed on each pouch. Such identifying information may include a horse name (in the case of equine materials being filled in the pouches), ship date, customer name, shipping barcode, or similar information.

Notably, a single order may include various different types of material (e.g., supplements) and thus, a different number of strips of 7 pouches may be provided. The identifying information will be printed in different areas based on the number of different materials in the order. For example, if an order includes a single material type, 4 strips of 7 pouches may be placed on rows 1, 3, 5, and 7 on the customization machine to activate 4 printers. As another example, if an order includes 2 different material types, the strips may be placed in rows 1, 2, and 5, 6 and printers in rows 1 and 5 may be activated. As another example, if the order includes 3 different material types, the strips may be placed in rows 1-3 and 5-7 and printers in rows 1 and 5 may be activated. As yet another example, if the order includes 4 different material types, the strips may be placed in rows 1-4, a printer in row 1 may be activated. Orders with greater than 4 different materials types may be printed similar to the 4 material type orders. Accordingly, by activating a different number of printers based on the number of different materials in an order, each daily strip may include identifying information.

### Cutting Process

Next, at step 4, the sheet of pouches is moved to a cutting area. The cutting area includes cutting devices (e.g., blades, hot wires, or the like) which cut the sheets into individual days to complete the daily material packaging unit. A step 5, each packaging unit may drop off the conveyer into a collection bin. The bin may be mounted on a separate conveyer to be automatically moved to a collection area. The bin may be automatically moved based on the completion of a number of cycles required per order. For example, for a single material type, 1 cycle may cause the bin to moved, 2 cycles for 2 or 3 materials types, and 4 cycles for 4-8 material types. Step 6 includes the bin moving from the conveyer toward a final organization area prior to shipping preparation. For example, in the organization area, the orders may be linked to shipping addresses and then moved to a packing area to be shipped to a customer.

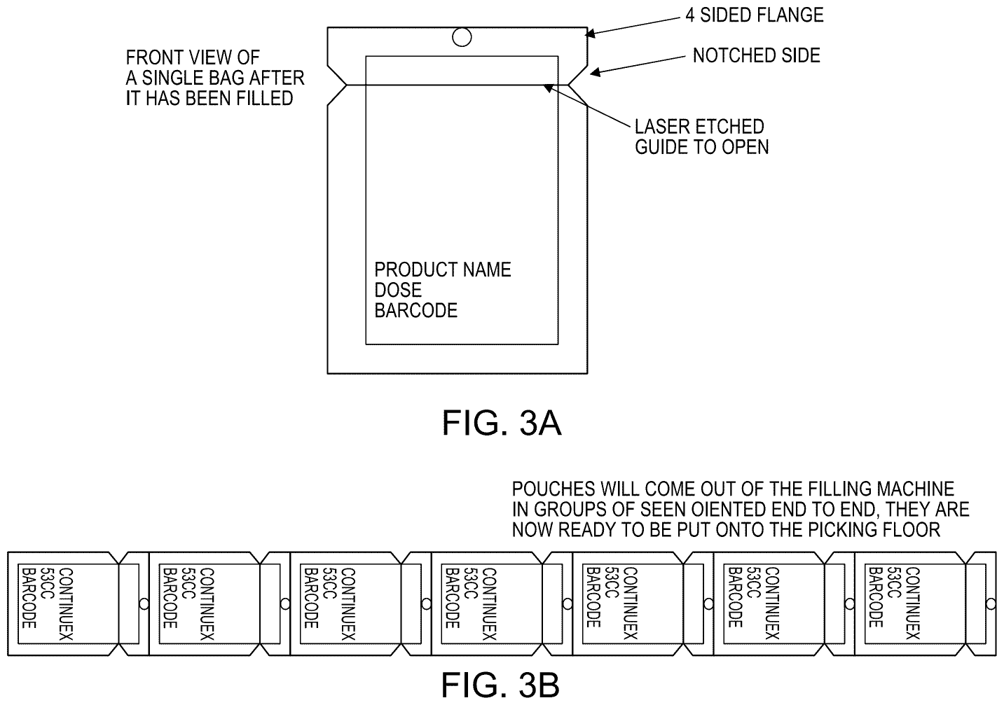

Moreover, details will now be provided of the pouches in reference to FIGS. 3A-5B according to an exemplary embodiment of the present disclosure. FIG. 3A illustrates a front view of a single pod after being filled. In particular, the pod includes a flange, an etched notch in the side of the pod to provide a guide for opening, and printed identifying information. As shown, the pod also includes a hole at a top thereof to facilitate an organization process as described above. FIG. 3B illustrates the above-described pouch in a group of 7 pods as filled by the filling machine described above. The pods are oriented end to end with overlapping flanges.

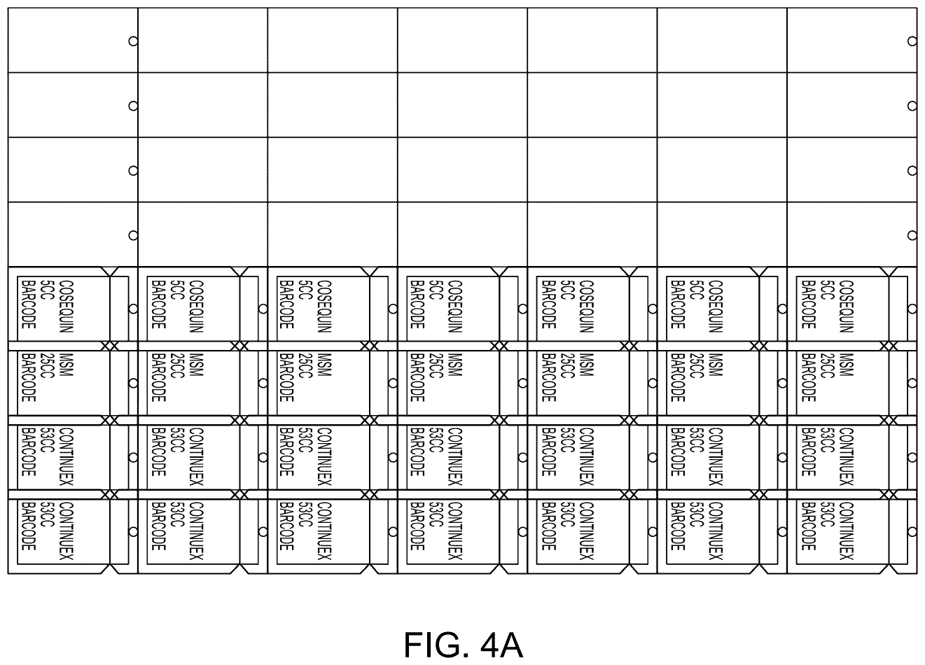

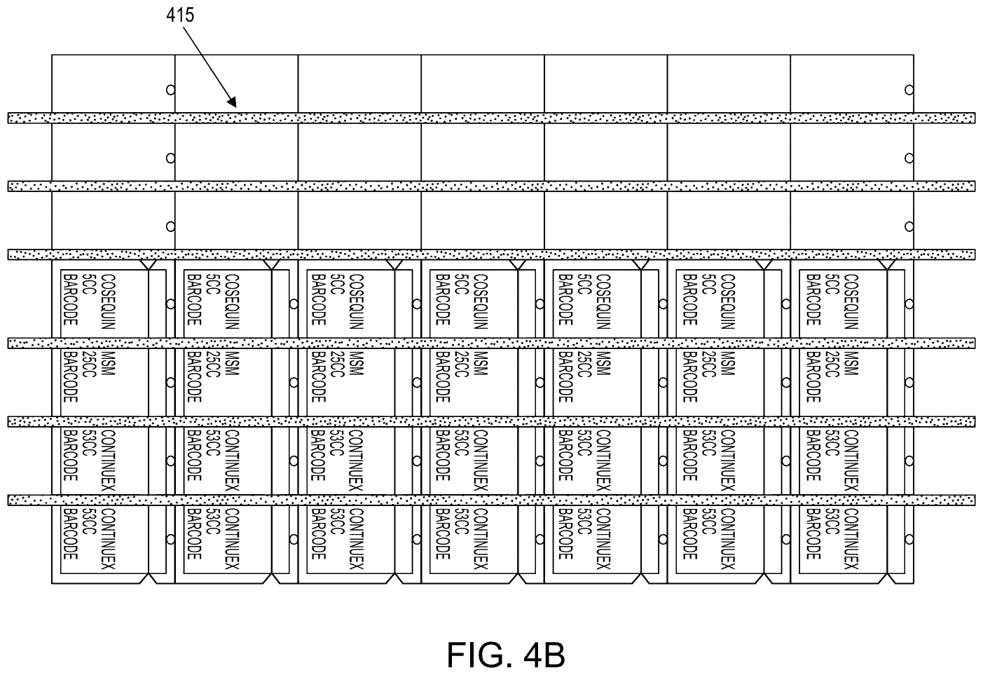

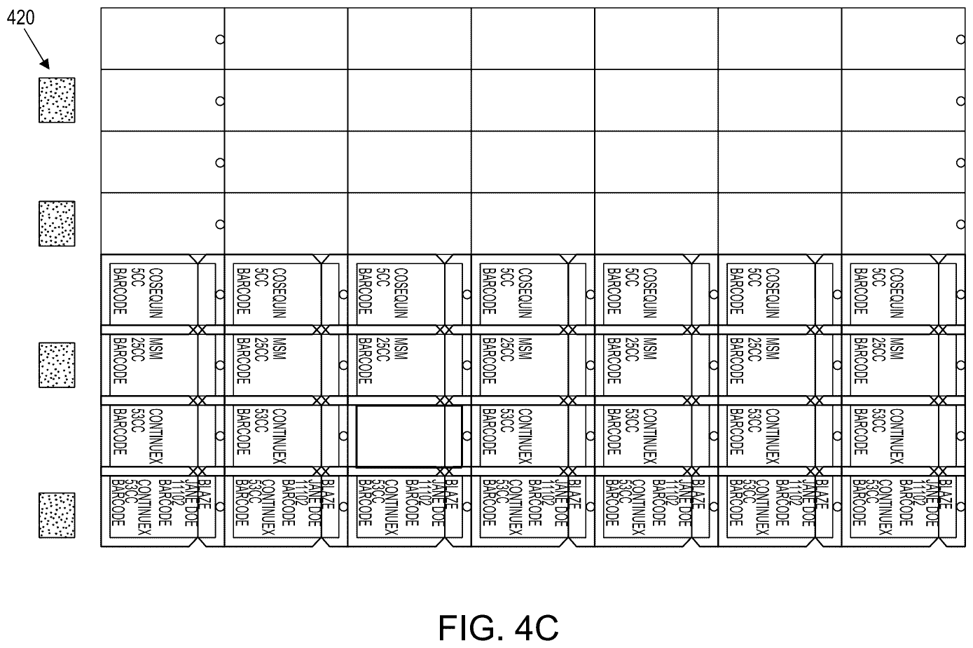

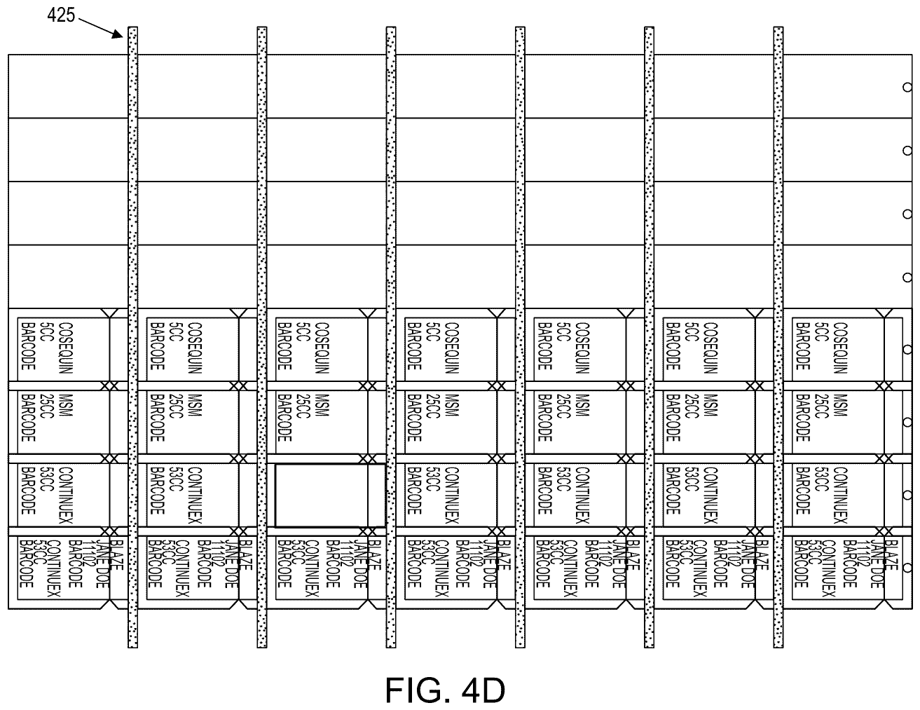

FIGS. 4A-4D illustrate the grouping of pouches through the customization process described above. In particular, FIG. 4A illustrates strips of 7 aligned using the hole at a top thereof. The holes may be attached onto pegs on the customization machine to ensure that the side flanges of each strip overlap. FIG. 4B illustrates the sealing process during which the side flanges are connected to thus form sheets of pouches. In particular, as described above, sealing bars 415 are lowered onto the pouches connect the side flanges by heat seal, infrared, ultrasonic, or similar connection method. FIG. 4C illustrates the printing process of the customization. In particular, the printer heads 420 are aligned based on the number of different materials in an order. In the exemplary embodiment of FIG. 4C, the printer heads 420 are located in rows 1, 3, 5, and 7 to print the identifying information on each pack. Lastly, FIG. 4D illustrates the cutters 425 operated to cut the sheet of pouches into individual packs based on the number of different materials in an order (e.g. a daily dose pack) to complete the manufacturing of the pack.

### Pod Opening/Stacking

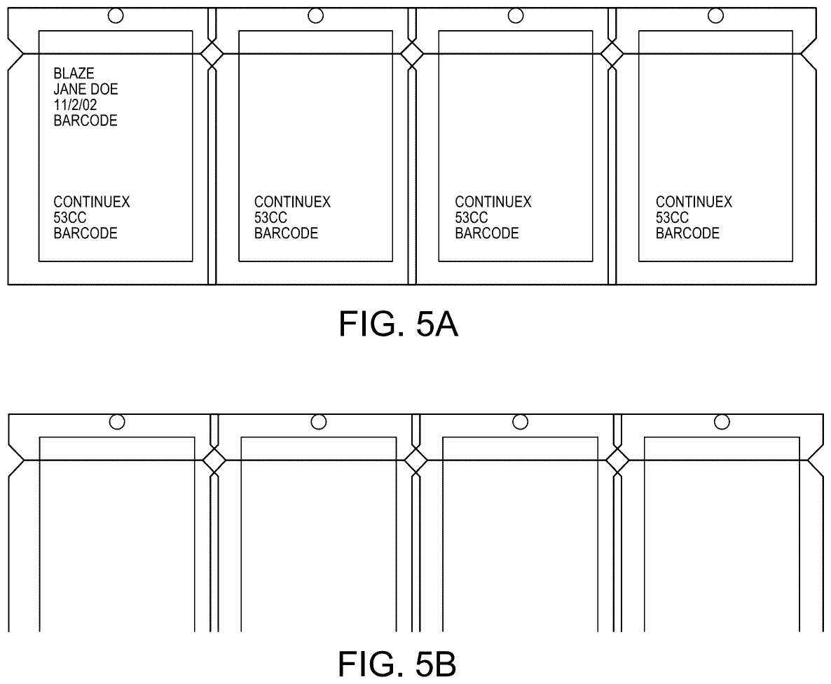

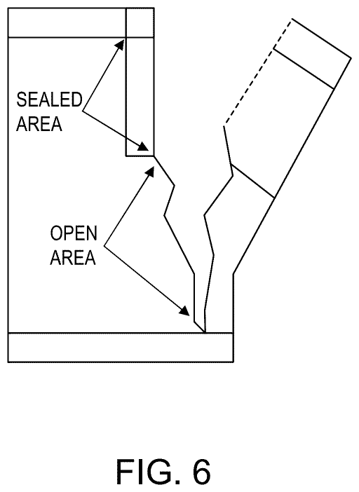

In further detail, FIGS. 5A-5B illustrate the completed pack from the customized machine. FIG. 5A illustrates a front view and FIG. 5B illustrates a back view. As shown, the pack includes 4 different pods connected together at sides. Each pod includes a notch to provide a guide for opening the pod. For example, the notch allows the top of the pod to be peeled to open the pod for dispensing the material therein. However, the present disclosure is not limited to the formation of a notch for opening guidance. For example, in another exemplary embodiment, a perforated tear line may be formed on each pod for opening guidance. The tear line may be formed vertically or horizontally. In such a configuration, as shown in FIG. 6, each pod may include a sealed area near the top of the pod. This sealed area prevents the material therein from spilling out during the initial opening of the perforated tear line. Each pack includes identifying information of the customer, horse name, and shipping date while each pod includes identifying information of the contents.

For shipping purposes, the completed packs of material may be stacked in varied directions to maximize the space within a shipping container. For example, a flipping device may be operated to rotate the finalized packs to alternate the packs in a row to nest the pods closely together. This stacking method also reduces damages to the pods during transmit to a shipping destination. Each stack of packs may be combined for a particular order and wrapped together. For example, a pile of stacks may be formed of 7 packs wide in 4 layers and thus, the 28 pods may be wrapped together to keep such an order together. Such a process also facilitates an organization process during movement to a shipping container.

Accordingly, the production method of packaged edible materials of the present disclosure provides a customized dose of materials in an efficient and cost reducing process.

### ALTERNATE EMBODIMENTS

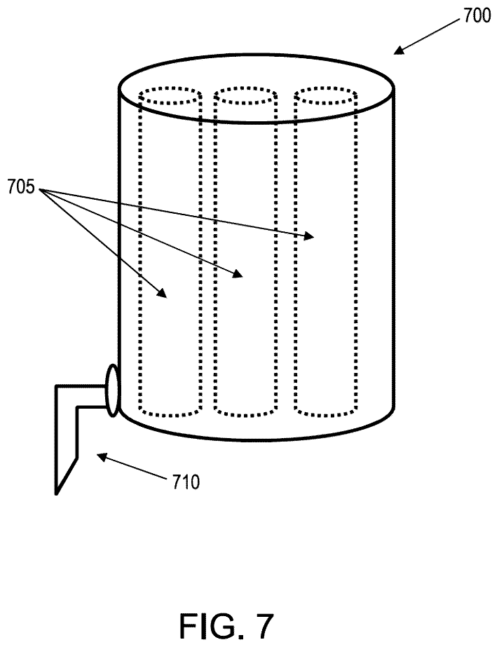

Another aspect of the present disclosure provides a feeding system as shown in FIG. 7 that is formed as a dispenser 700 that outputs a pre-measured amount of feed. For example, such a system may read a code (on a label or the like scanned by the system) which is indicative of a particular horse being fed. The system may then access a database for the particular horse to determine the exact customized amounted of intended feed, ration balancer, supplement, or the like and then dispense the material. Many different edible materials may be stored in a reservoir of the system. For example, the system may house a plurality of containers 705 each containing a different edible material that are all dispensed through an output 710 based on the programmed amount of intended feed. Such a system eliminates the need for individualized measuring to be done manually and also improves feed accuracy for the horses. In addition, this system reduces the overall time required for feeding.

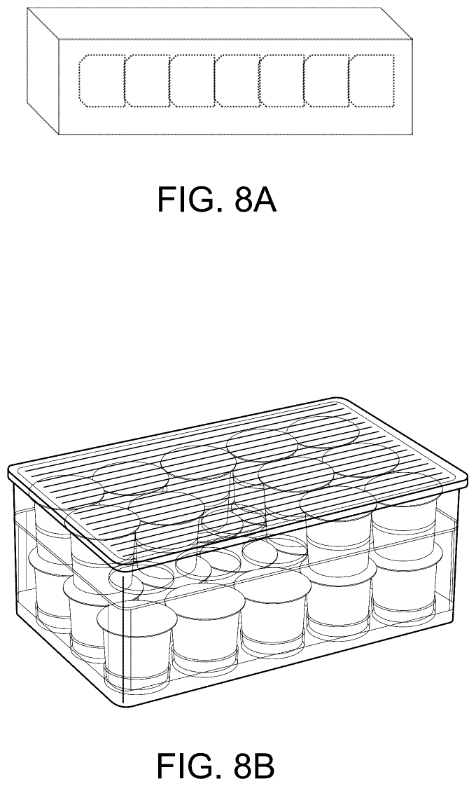

According to yet another exemplary embodiment of the present disclosure and as shown in FIGS. 8A-8B, the pouches or pods may be stored in various containers for shipping to a customer or for storage. For example, as shown in FIG. 8A, a predetermined number of pods may be stored together in a sleeve-like container or box. Each individual pouch may then be ripped from the group due to the etch formed at each individual pouch at the connecting joint of neighboring pouches. In the strips of sleeves described above with reference to FIG. 3B, a plurality of strips may be stacked within the sleeve or box. Accordingly, a strip containing a week supply of feed may be stored within the sleeve. As another example, four strips of a week supply of feed (e.g., 7 pouches in a strip) may be stored or shipped within a sleeve to provide a month's worth of feed for a particular horse. The sleeve box itself may also contain printed information of the particular feed included in each strip or the individual pods. Additionally, the printed information may include a particular horse's name to easily distinguish between the sleeves of other horses. This information may also be replicated on the strips within the sleeve-like box.

Alternately, as shown in FIG. 8B, the pods of feed may be stacked within a box container. In one example, the container may include apertures holding each pod in place therein. In another example, the pods may be stacked in alternating directions to maximize the space within the container. The pods within the container may be divided into multiple compartments to contain multiple edible materials. Alternately, each pod may contain only one edible material. The present disclosure is not limited to the number of materials filled within each pod.

### Pouch Material

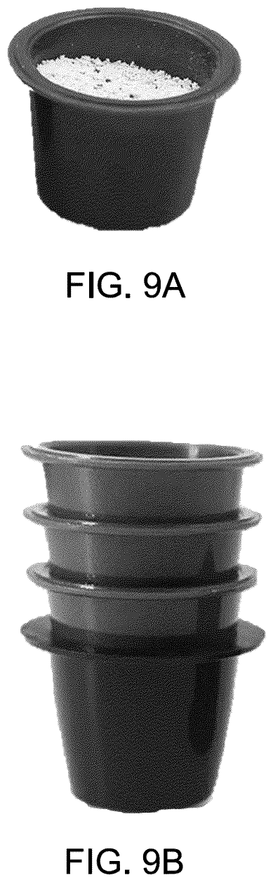

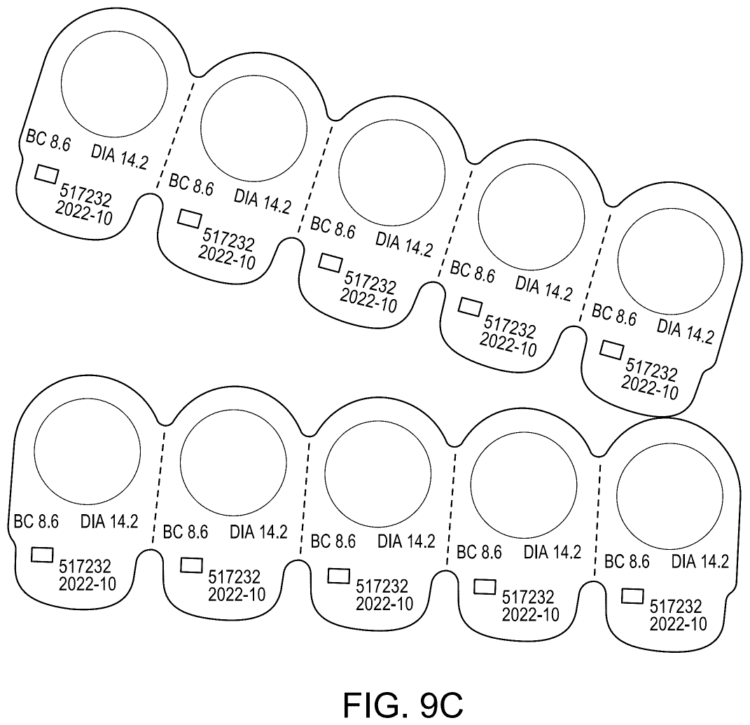

Notably, the material of the pouches described herein may be widely varied. First, FIG. 9A illustrates a pod-type pouch in which edible material is filled. As shown in FIG. 9B, the pods may be formed to be stackable. Such a structure is beneficial both when storing used pods for recycling or for reusing the pods. The pods shown in FIGS. 9A-9B may be made of various materials included polyethylene terephthalate (PET) or other similar type of material. These types of pods may be sealed with a lidstock of varying materials. In one example, the pods may be connected in a predetermined number. That is, the lidstock sealing each pod may be formed as one strip holding a group of pods together. As one example, a strip of lidstock may be sealed over 7 pods to provide a week's worth of food. FIG. 9C illustrates a strip of pods connected by a lidstock. As shown, the lidstock may be peelable and may also be perforated between each individual pod to either open all pods at once or individually. In an alternate embodiment, a divider may be provided within the pouch such that each material filled therein is separated from each other.

The lidstock may include printed material regarding the contents of the pods, equine identification information, package date, and the like. Notably, the present disclosure is not limited to the pods being held together by a lidstock and other attaching variations may be used. For example, a predetermined number of pods may be manufactured to be connected by a tab, wherein each pod is capable of being snapped off the group of pods for a single serving of feed.

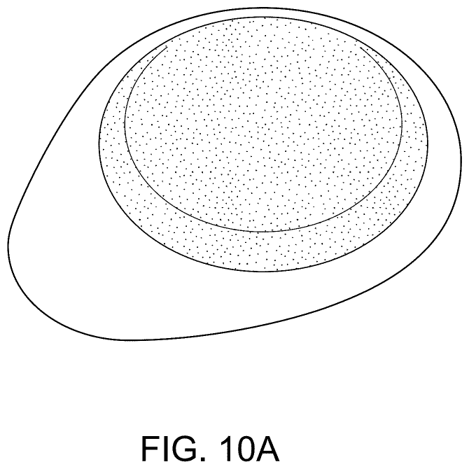

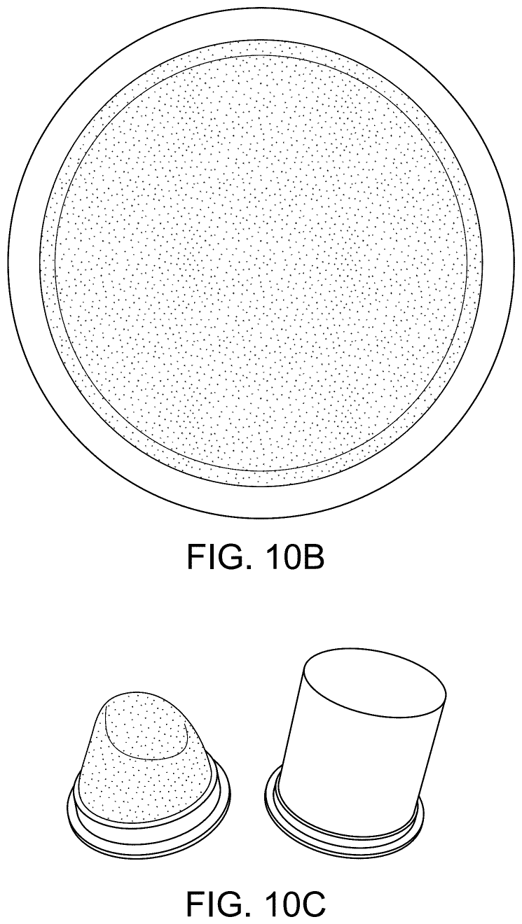

Additionally, as shown in FIGS. 10A-10C, the pouch material may be a film capable of breaking down organically over time. This material may then be added to a compost thus eliminating the need to dispose the empty pouches and reducing excess waste. Similarly, the pouch material may be made of a paper material that breaks down when wet thus also being able to be added to a compost as shown in FIG. 10A. For example, these pods may be formed as individual disc shapes. The example shown in FIG. 10A includes an optional tab. The tab may be pulled apart to release the feed filled therein.

In particular aspects, the pouches may be made of a biodegradable or compostable material. The pouch material may also be made of natural materials that are edible (e.g., corn starch material) such that a pouch may be fed directly to the horse. For example, FIG. 10B provides such a disc shaped pod made of an edible material. The present disclosure is not limited to the particular shape shown in FIG. 10B. This material would eliminate reliance on plastic and also reduce excess waste. As another example, the pouch material may be recyclable or reusable (e.g., metal, aluminum, stainless steel, etc.) such that the pouches could be reused. In another embodiment, the pouches may be formed to be collapsible or to break down into smaller pieces as shown in FIG. 10C. That is, FIG. 10C shows a full pod collapsed over time.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

1. A method for producing packaged edible materials comprising:
selecting one or more edible materials and amount thereof based on a purchaser's input;
dispensing each of the edible materials to a packaging unit;
sealing side and ends of the packaging unit;
separating the packaging unit into a predetermined number of pods; and
analyzing each pod of the packaging unit that contains the edible material for one or more of: metal levels, weight and optical characteristics.

2. The method of claim 1, wherein the packaging unit is formed out of a roll of film material.

3. The method of claim 2, wherein the roll of film material is folded in half and sealed on sides and ends thereof to form the packaging unit.

4. (canceled)

5. The method of claim 1 wherein based on a purchaser's input each of the following are selected: 1) one or more edible materials and amount thereof; 2) packing unit; and 3) shipping date.

6. The method of claim 5 wherein the purchaser's input is stored in and accessed from a database.

7. The method of claim 1 wherein identifying information is added to the packaging unit.

8. The method of claim 7 wherein the identifying information includes 1) edible material in the pod; 2) amount of edible material in the pod; and 3) indication of number of pods in packaging unit.

9. The method of claim 1 wherein the packaging unit includes a detectable tag.

10. The method of claim 9, wherein the tag comprises RFID.

11. The method of any one of claim 10 wherein the packaging unit advances via a transport system through process stations during steps of dispensing and analyzing.

12. The method of claim 11 further comprising stacking multiple packaging units together.

13. The method of claim 12 wherein multiple packaging units are stacked laterally and vertically.

14. The method of claim 12 wherein packaging units are stacked in varying configurations.

15. The method of claim 12 wherein adjacent packaging units are stacked in varying positions.

16. The method of claim 12 wherein a first portion of the packaging units are stacked in an inverted position with respect to a second portion of the packaging units.

17. The method of claim 12 wherein one or more stacks of packaging units are transferred to a shipping container.

18. The method of claim 17, wherein an interior surface of the film material is resistant to air and water.

19. The method of claim 18, wherein the edible materials are equine feed or supplements.

20. The method of claim 19, wherein each pod is divided into a plurality of sections based on the number of edible materials dispensed thereinto.

21. The method of claim 1, wherein each pod is made of an edible or compostable film.

22. The method of claim 1, wherein each pod is made of a paper material.

23. The method of claim 1, where each pod is collapsible.

24. An edible material dispensing apparatus, comprising:
a reservoir in which a plurality of different edible materials are stored;
an output through which the edible materials are dispensed; and
a controller configured to read a personalized code and dispense a predetermined amount and predetermined combination of edible materials through the output based on the personalized code.

25. A method for producing packaged edible materials comprising:
selecting one or more edible materials and amount thereof based on a purchaser's input;
dispensing the edible materials into separate sections within a packaging unit;
sealing the packaging unit;
separating the packaging unit into a predetermined number of pods, each pod containing the separation sections; and
analyzing each pod of the packaging unit that contains the edible material for one or more of: metal levels, weight and optical characteristics.

26-30. (canceled)
